(19) United States
(12) Patent Application Publication
(10) Pub. No.: US 2013/0117380 A1
(43) Pub. Date: May 9, 2013

(54) DYNAMIC CONTENT GENERATION IN EMAIL MESSAGES

(71) Applicants: Igor Pomazanov, Pacheco, CA (US); Alexander Konkin, Pleasanton, CA (US)

(72) Inventors: Igor Pomazanov, Pacheco, CA (US); Alexander Konkin, Pleasanton, CA (US)

(73) Assignee: eBay Inc., San Jose, CA (US)

(21) Appl. No.: 13/288,757

(22) Filed: Nov. 3, 2011

(51) Int. Cl. G06F 15/16

(52) U.S. Cl. 709/206

(57) ABSTRACT

Certain embodiments enable improved email communications by including a dynamic-content section in an email where the dynamic-content section is updated with current values when the email is opened by a user. Both the user and the dynamic content may be selected based on network behavior of the user as well as other characteristics of the network.

### BACKGROUND

1. Technical Field

The present disclosure relates generally to information processing and more particularly to email communications in a network.

2. Description of Related Art

Email messages are typically sent with static content that remains unchanged after the message is sent. Updates to previously sent email have generally been limited to specific changes from the original sender where these changes may not be the most up to date content when the email is opened by the recipient (U.S. Pat. No. 7,478,132). Thus, there is a need for improved email communications in a networked system.

### BRIEF DESCRIPTION OF THE DRAWINGS

FIG. 1 is a flowchart that shows a method of providing dynamic email content according to an example embodiment.

FIG. 2 is a diagram that shows aspects of email messages for the embodiment of FIG. 1.

FIG. 3 is a code listing that shows a dynamic-content section for the embodiment of FIG. 1.

FIG. 4 is an image that shows dynamic content for the embodiment of FIG. 1.

FIG. 5 is another image that shows dynamic content for the embodiment of FIG. 1.

FIG. 6 is another image that shows dynamic content for the embodiment of FIG. 1.

FIG. 7 is a flowchart that shows a method of selecting a user for an example embodiment.

FIG. 8 is an image that shows an interface related to the method of FIG. 7.

FIG. 9 is another image that shows an interface related to the method of FIG. 7.

FIG. 10 is another image that shows an interface related to the method of FIG. 7.

FIG. 11 is another image that shows an interface related to the method of FIG. 7.

FIG. 12 is a flowchart that shows a method of determining the current values of the dynamic content for an example embodiment.

FIG. 13 is an image that shows an interface related to the method of FIG. 12.

FIG. 14 is another image that shows an interface related to the method of FIG. 12.

FIG. 15 is a block diagram that shows a schematic representation of an apparatus for an example embodiment.

FIG. 16 is a network diagram that shows a client-server system for an example embodiment.

FIG. 17 is a block diagram that shows multiple applications for the embodiment of FIG. 16.

FIG. 18 is a high-level entity-relationship diagram that shows aspects of tables as applied to the embodiment of FIG. 16.

FIG. 19 is a block diagram that shows further details of the tables of FIG. 18.

FIG. 20 is a diagram that shows a computer processing system within which a set of instructions for causing the computer to perform any one of the methodologies discussed herein may be executed.

### DETAILED DESCRIPTION

Certain embodiments enable improved email communications by including a dynamic-content section in an email where the dynamic-content section is updated with current values when the email is opened (e.g., accessed) by a user. Both the user and the dynamic content may be selected based on the network behaviour of the user as well as other characteristics of the network.

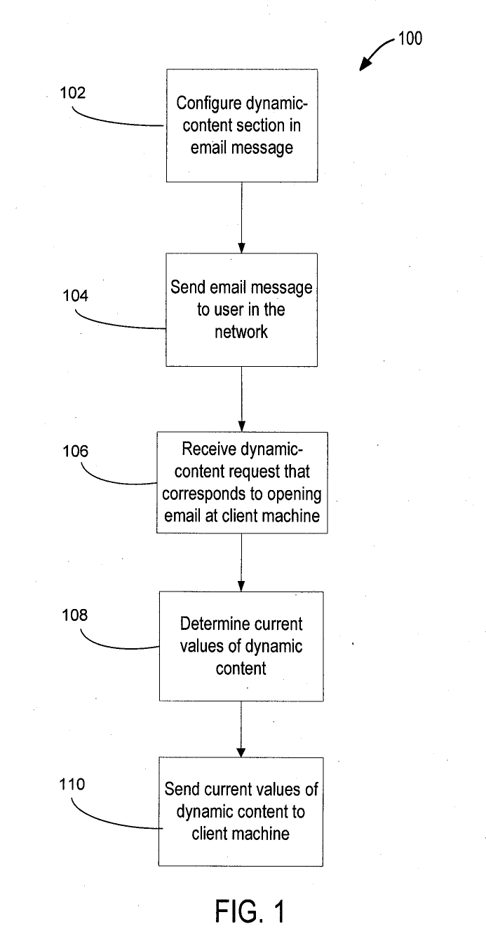

FIG. 1 shows a flowchart that illustrates a method 100 of providing dynamic email content according to an example embodiment. A first block 102 includes configuring a dynamic-content section in an email message to access dynamic content over a network when the email message is opened at a client machine in the network. As discussed below, the dynamic-content section includes a network command to request the dynamic content when the email is opened and at least one display parameter to control a display of the dynamic content in the email message at the client machine.

A second block 104 includes sending the email message to a user in the network. A third block 106 includes receiving a dynamic-content request that corresponds to opening the email message at the client machine. A fourth block 108 includes determining current values of the dynamic content in response to receiving the dynamic-content request. A fifth block 110 includes sending the current values of the dynamic content to the client machine for display in the email message at the client machine.

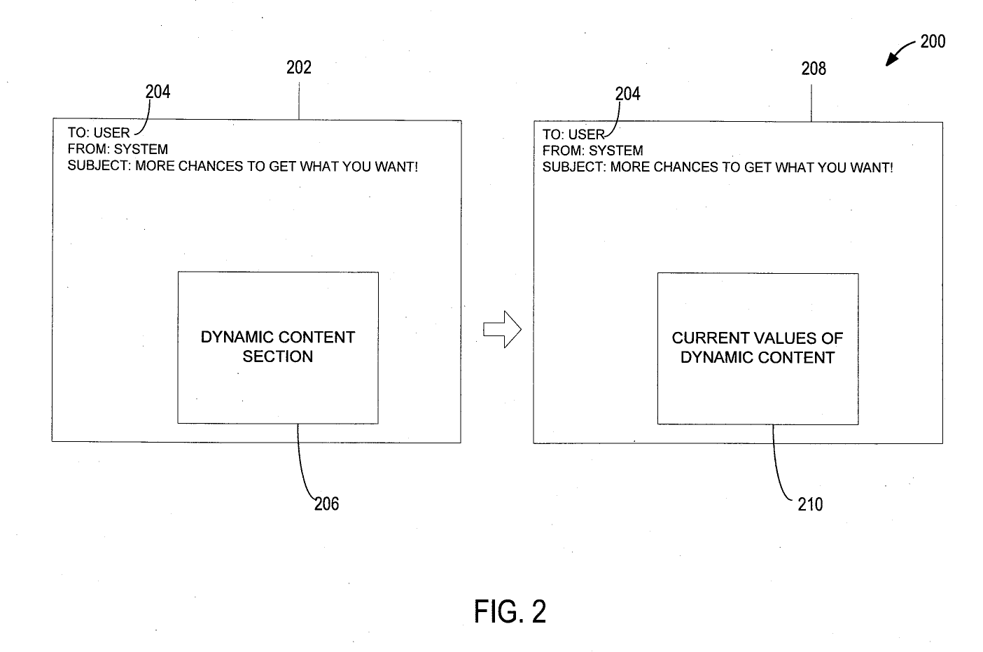

FIG. 2 shows a diagram 200 that illustrates the embodiment of FIG. 1. An email message 202 is addressed to a user 204 and configured to include a dynamic-content section 206. When opened (e.g., accessed) by the user 204 at the client machine, the email message 208 includes current values 210 of dynamic content in place of dynamic-content section 206 in the original email 202.

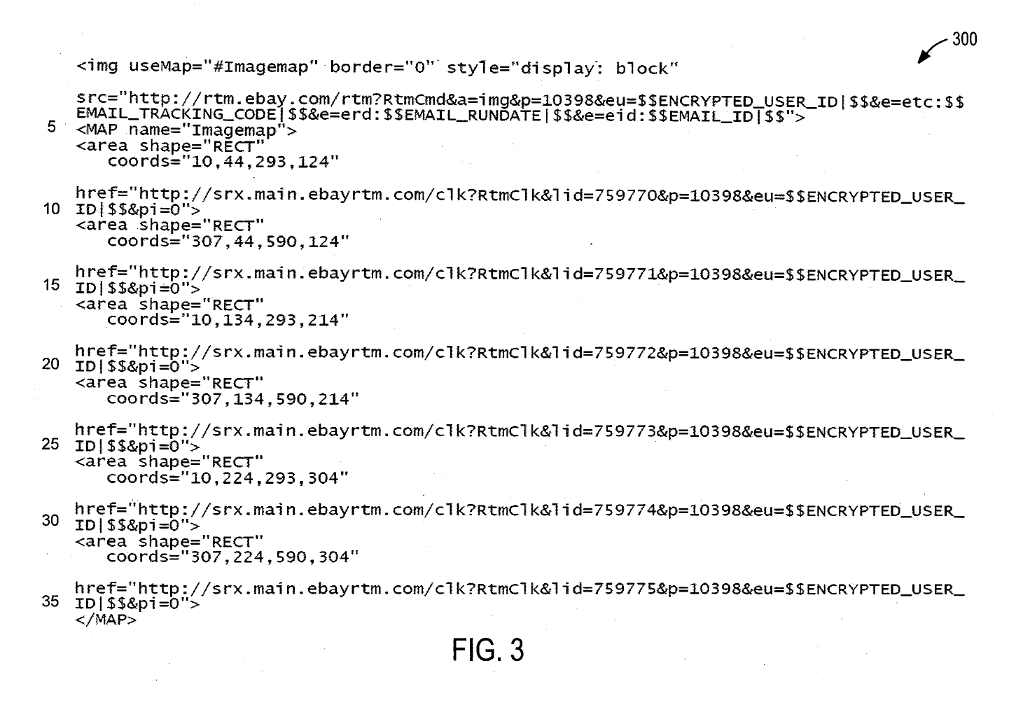

FIG. 3 shows a Hypertext Markup Language (HTML) snippet 300 (e.g., an HTML code section) that functions as a dynamic-content section 206. The snippet 300 is bounded at lines 1 and 36 by control commands including a usemap attribute that defines a client-side image with clickable areas. The image source is defined by the HTML attribute src (line 3), which includes tracking and other control features of the email message that are populated when the email is sent to the user (e.g., to keep track of which messages are being sent to the user). Further details include a 3×2 array of clickable areas. For example, the first area includes the shape specification “RECT” (line 6), coordinates for the shape (line 7), and an attribute (href) that gives a link to an external site using the Hypertext Transfer Protocol (HTTP). The other five areas are similarly specified. When the email message 208 is opened by the user 204, this HTML snippet 300 effectively makes HTTP requests to an identified server to fetch dynamic content in the form of an image for each of the areas. The request information passed to the server typically includes an encrypted user ID and other tracking information (e.g., lines 9-10). Although this example shows a single HTML snippet 300, an arbitrary number of HTML snippets may be included in the email message 202.

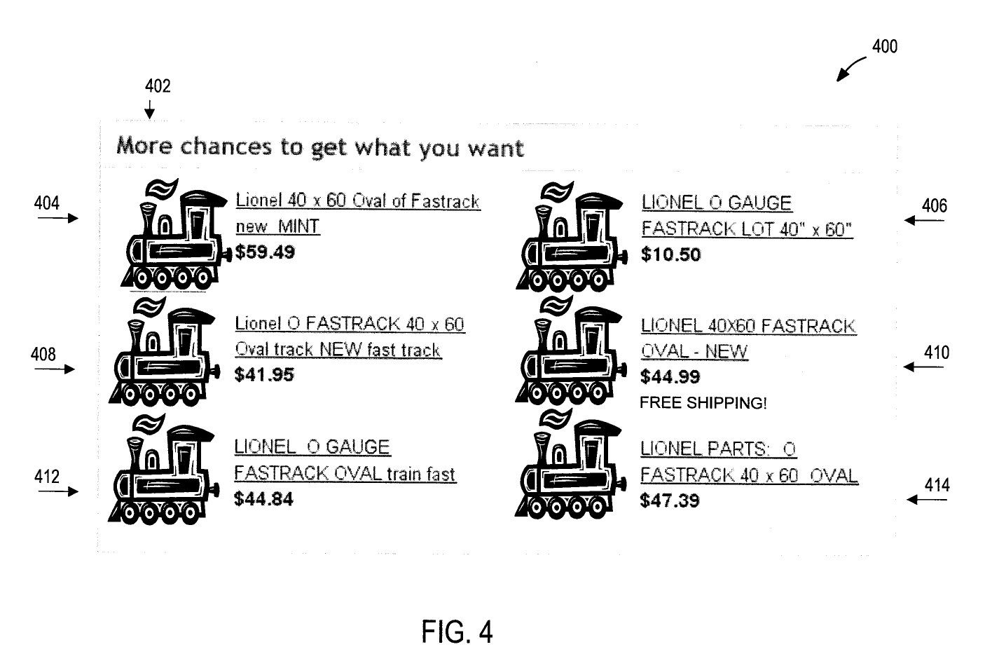

FIG. 4 shows a dynamic-content image 400 that represents the current values 210 of the dynamic content as displayed in the user's email at the client machine. A dynamically generated title 402 is shown at the top of the image 400. The 3×2 array of clickable areas includes six elements 404, 406, 408, 410, 412, 414. Each element 404-414 includes an image, a description, and a price. (In this case, the six element images are identical. In general, each element image may be different.) Note that the fourth element 410 includes an additional description for “free shipping.” Depending on the details of the implementation, additional descriptions are also possible (e.g., for promotional offers with expiration dates). As discussed above, each element 404-414 is a clickable area that allows the user to access the corresponding site where the item is offered for sale.

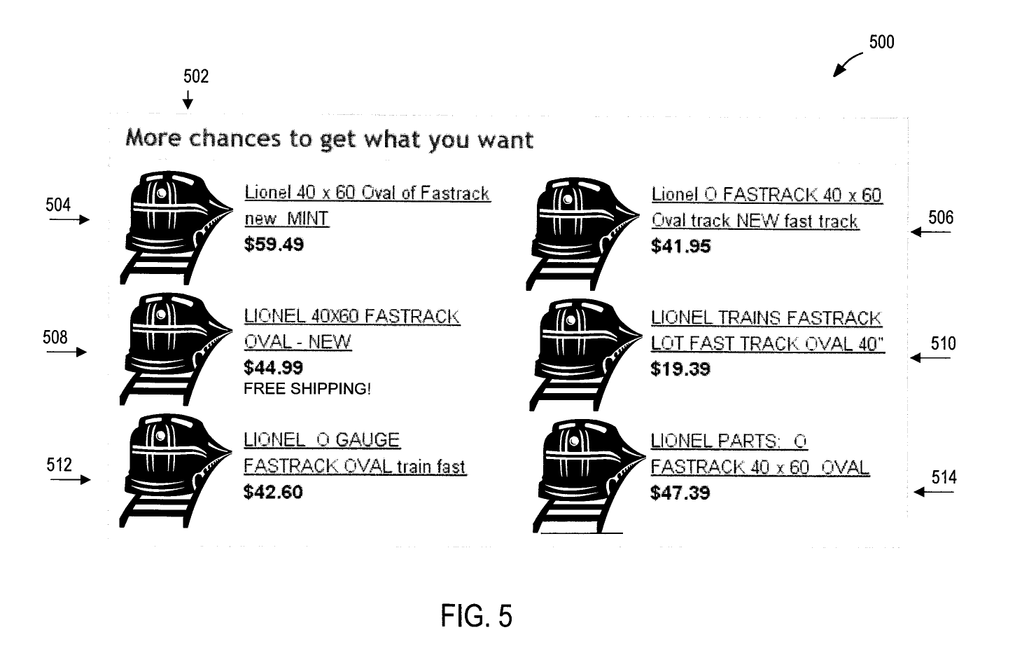

As discussed above, each time the user opens the email message 208, new current values 210 are generated for display in the user's email at the client machine. FIG. 5 shows another dynamic-content image 500 that represents the current values 210 of the dynamic content as displayed in the user's email at the client machine. As in the previous dynamic-content image 400, a dynamically generated title 502 is shown at the top of the image 500. The 3×2 array of clickable areas includes six elements 504, 506, 508, 510, 512, 514. Each element 504-514 includes an image, a description, and a price. (As in the previous dynamic-content image 400, the six element images are identical.) Note that the third element 508 includes an additional description for “free shipping.” As discussed above, each element 504-514 is a clickable area that allows the user to access the corresponding site where the item is offered for sale.

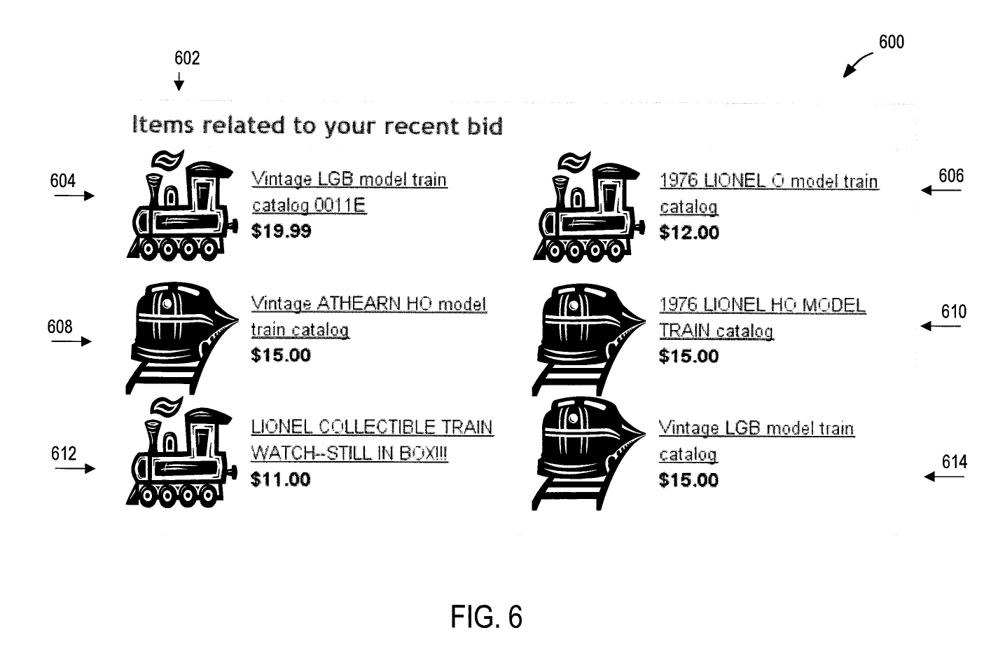

FIG. 6 shows another dynamic-content image 600 that represents the current values 210 of the dynamic content as displayed in the user's email at the client machine. As in previous dynamic-content images 400, 500, a dynamically generated title 602 is shown at the top of the image 600. (In this case the title 602 is different from the previous titles 402, 502.) The 3×2 array of clickable areas includes six elements 604, 606, 608, 610, 612, 614. Each element 604-614 includes an image, a description, and a price. (As compared with the previous dynamic-content images 400, 500, a different arrangement of element images is shown.) In this case none of the elements 604-614 includes an additional description for “free shipping.” As discussed above, each element 604-614 is a clickable area that allows the user to access the corresponding site where the item is offered for sale.

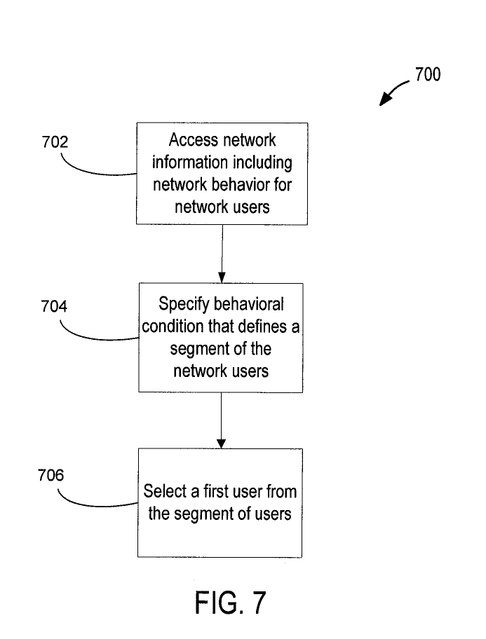

The user 204 who receives the email may be a first user that is selected from a larger group of users where this group is defined by the users' network behaviour including, for example, sites visited, sites not visited, searches requested, and searches not requested. FIG. 7 shows a flowchart that illustrates a method 700 of selecting the first user for an example embodiment. A first block 702 includes accessing network information that includes aspects of network behavior for multiple users. For example, the network behavior may include one or more of sites visited, sites not visited, searches requested or searches not requested. A second block 704 includes specifying at least one behavioral condition that defines a segment of users by restricting the network behavior relative to the plurality of users. For example, the segment may be defined as users who have visited specific sites or categories of sites within a recent time period. A third block 706 includes selecting the first user from the segment of users. The selection may be random or possibly based on another aspect of network behavior. For example, if the segment is defined based on a category of sites visited, the selection may be based on the number of different sites visited within the category or the number of related searches carried out by the user.

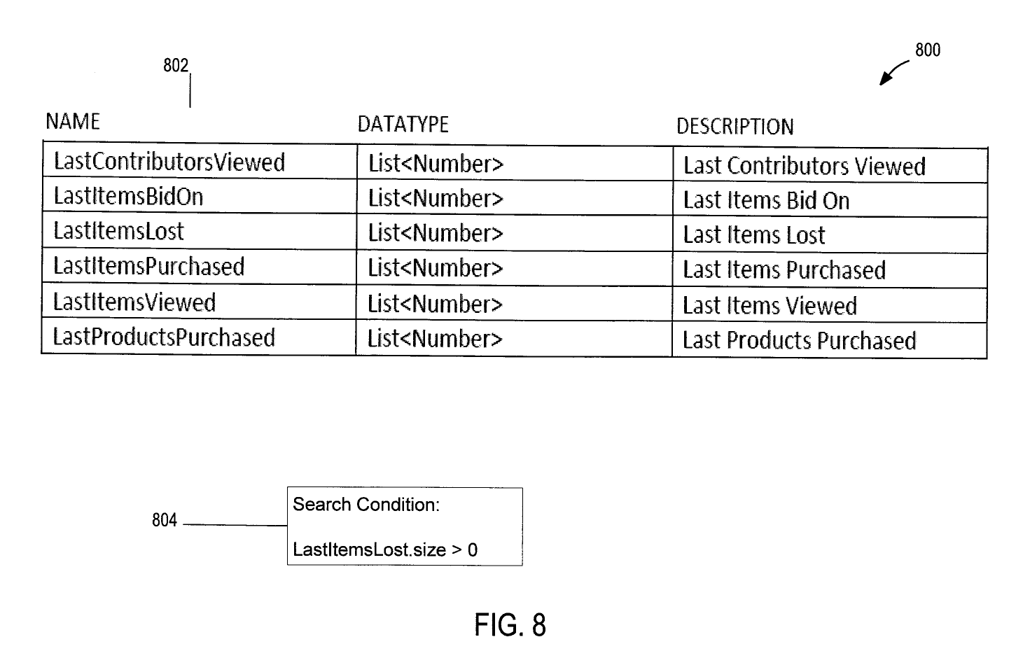

FIGS. 8-11 show further details related to example embodiments for specifying one or more behavioral conditions that define a segment of users by restricting the network behavior relative to the plurality of users (e.g., block 704). These behavioral conditions may include, for example, transactions carried out or not carried out by a user and searches carried out or not carried out by user. In some cases, a user's presence on a distribution list or mailing list can be used to identify user behaviour (e.g., interest level in a subject).

FIG. 8 shows display sections 800 related to an interface for selecting the one or more users. A menu display 802 with fields for name, data type and description shows options for defining network behavior. The menu display 802 includes entries for last contributors viewed, last items bin on, last items lost, last items purchased, last items viewed, and last products purchased. A related search condition 804 specifies that at least one item was lost (e.g., from a watch list).

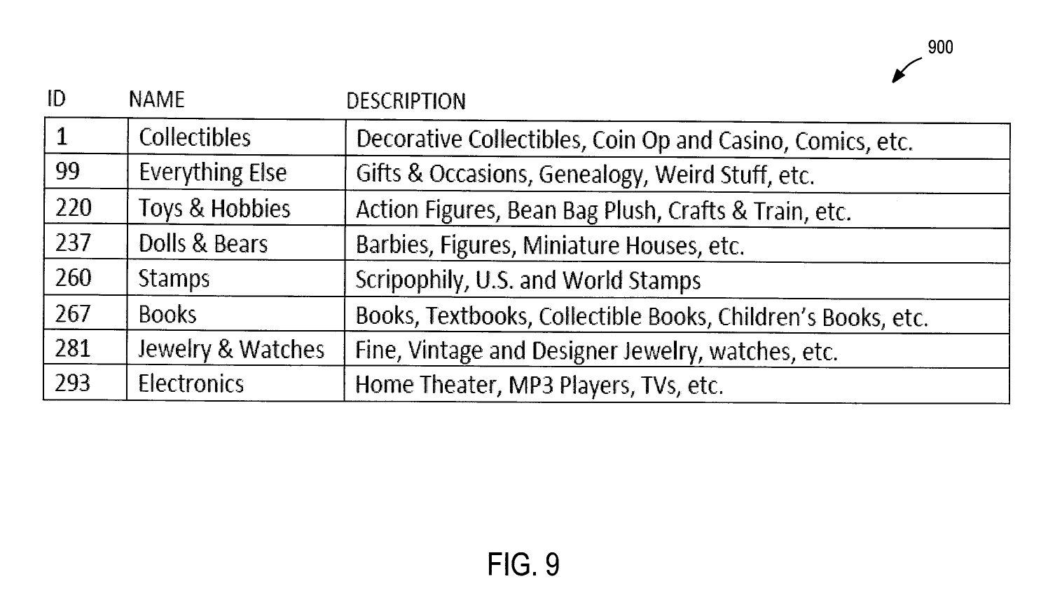

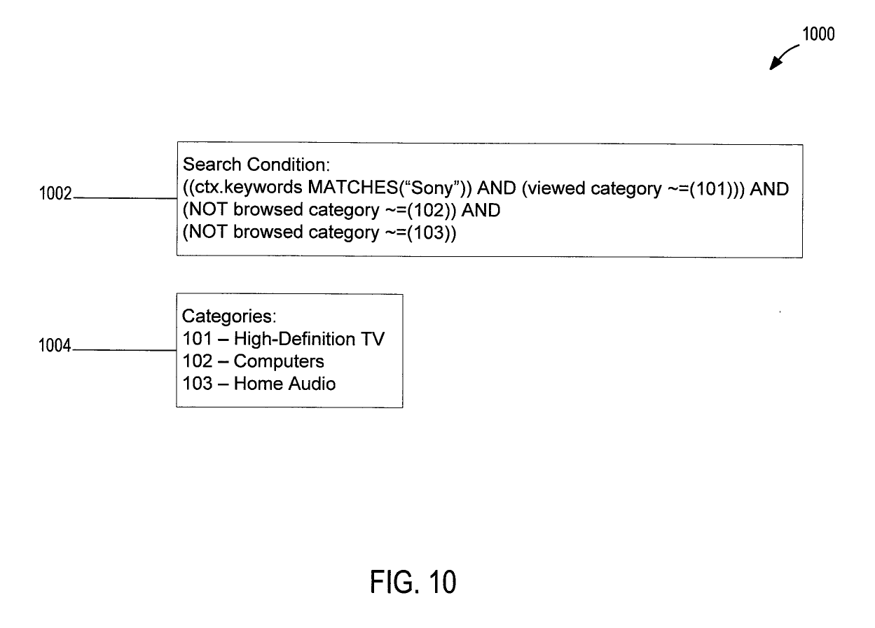

Product categories and sub-categories may be employed for selecting the user as well as the dynamic content. FIG. 9 shows a menu display 900 with fields for an identifier (ID), name, and description. The menu display 900 includes entries for collectibles, everything else, toys and hobbies, dolls and bears, stamps, books, jewelry and watches, and electronics. For example, a row of the display may be highlighted to indicate that it has been selected. FIG. 10 shows display sections 1000 related to a identifying a segment of users including a search condition 1002 and category IDs (e.g., as in FIG. 9). In this case the search condition is directed to users who searched for “Sony” and viewed the high-definition-TV category but did not browse in either the computer category or the home-audio category.

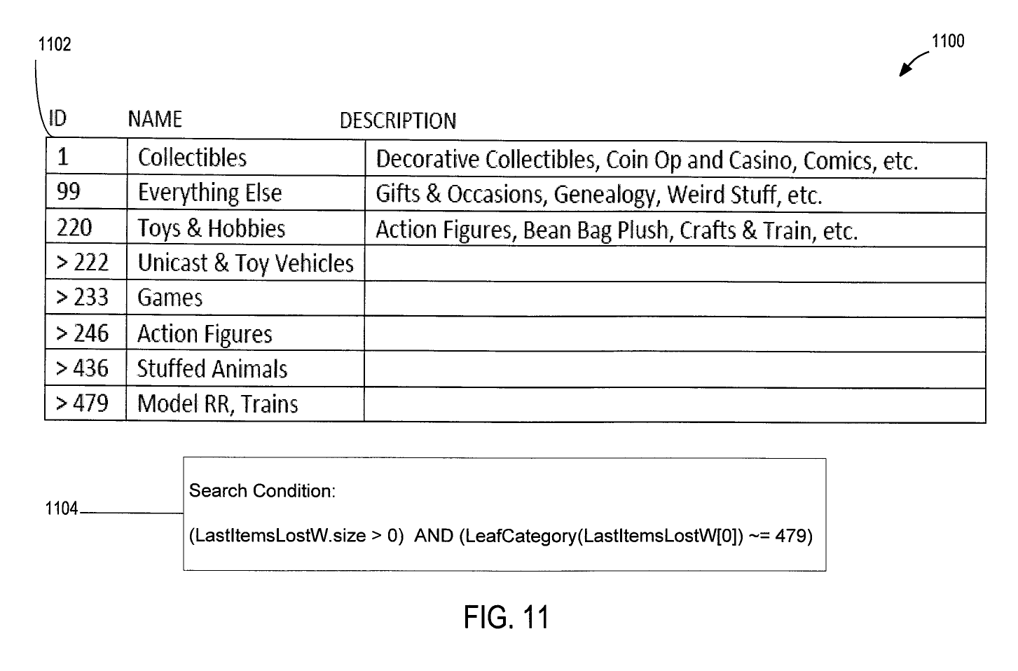

FIG. 11 shows additional display sections 1102 related to an interface for using categories to select the user. A menu display 1102 with fields for ID, name, and description includes entries for the categories collectibles, everything else, and toys and hobbies. Sub-category entries for toys and hobbies include die-cast and toy vehicles, games, action figures, stuffed animals, and model railroads and trains. For example, a row of the display may be highlighted to indicate that it has been selected. A search condition 1104 is directed to a modification of FIG. 8′s search condition 804, which specifies that at least one item was lost (e.g., from a watch list). In this case, the sub-category of the lost item is further specified as the selected category “model railroads and trains” with ID=479.

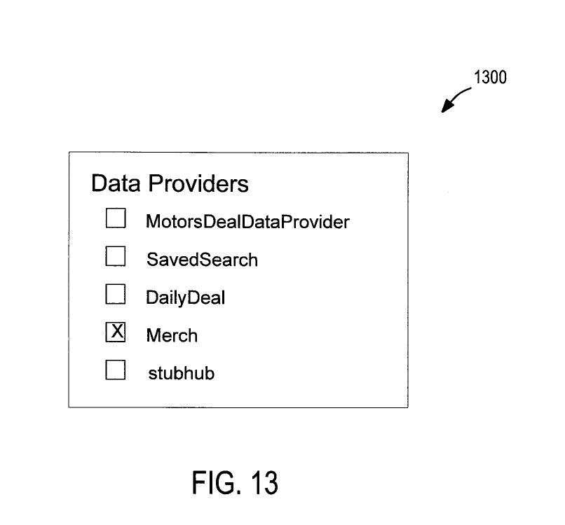

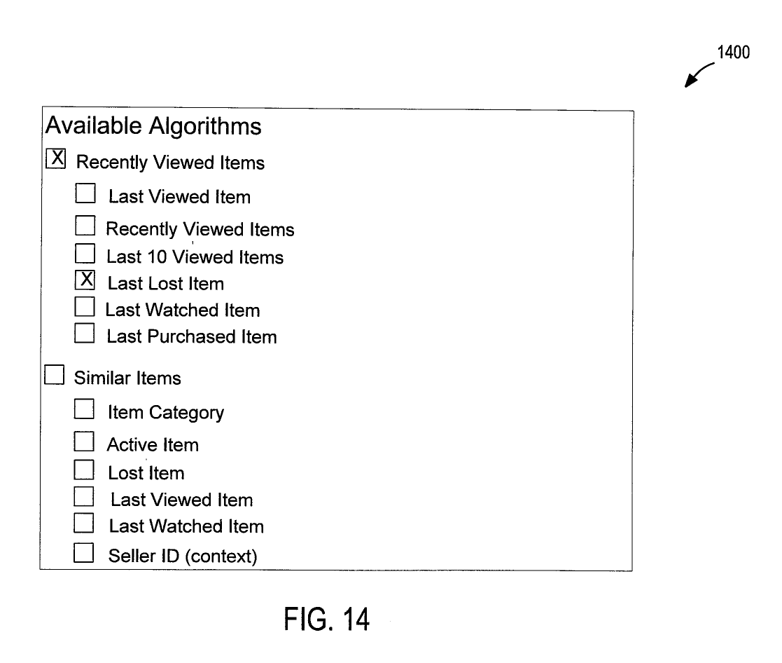

The current values 210 of the dynamic content may be determined by executing a search where the search criterion may be based on the user's network behaviour (e.g., sites visited, sites not visited, searches requested, and searches not requested). For example, the interfaces similar to the ones shown in FIGS. 8-11 may be used to identify the search criterion for the dynamic content (e.g., corresponding to an item that was lost as in the search condition 1104). As discussed below, FIG. 14 shows an interface related to available algorithms for determining the dynamic content based on the user's network behavior. Additionally or alternatively, dynamic content may be based on contextual identifiers of corresponding web sites so that the dynamic content can be more specifically defined when the current values 210 are accessed. For example, the contextual identifies may relate to geographic context (e.g., country, city), demographic context (e.g., targeted age-group, targeted income group) or categorical context (e.g., product specialty sites). As discussed below, FIG. 13 shows an interface related specifying data providers for the dynamic content where these data providers also include certain algorithms that access the user's network behaviour.

In response to receiving the dynamic-content request (e.g., as in block 106), an access record corresponding to user may be saved in a storage system and used for determining subsequent values for dynamic content based on subsequent dynamic-content requests. In this way, the network behaviour of the user may affect subsequently determined values of dynamic content. For example, previous values for dynamic content may be omitted from the current values when the email message is opened a second or third time. Alternatively, some previous value for dynamic content may be repeated with emphasis. In some cases, the search criterion for determining the dynamic content may be changed between the time when the email message 202 is sent to the user 204 and the time when the email message 208 is opened by the user 204 (e.g., updated based on user behaviour). It should be noted that the email message may be opened by the user at a single client machine or at different client machines in the network (e.g., when the user changes locations).

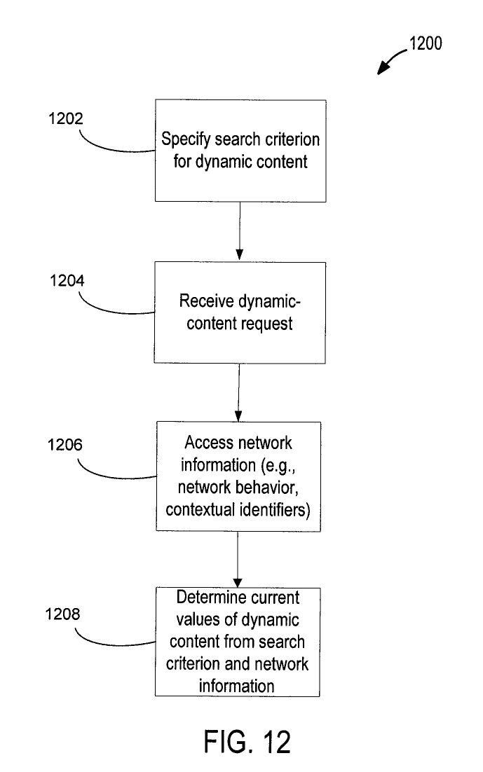

FIG. 12 shows a flowchart that illustrates a method 1200 of determining the current values 210 of the dynamic content based on some combination of the user's network behavior and other network information. A first block 1202 includes specifying a search condition for the dynamic content. For example, the search condition may be some modification of a previous search by the user or some other network behavior of the user (e.g., based on an item lost from the user's watch list). A second block 1204 includes receiving a dynamic content request (e.g., as in block 106 of FIG. 1). A third block 1206 includes accessing network information, which may include network behavior of the user 304 or other users (e.g., sites visited or not visited, searches executed or not executed) and context identifiers for web sites (e.g., category Ids, demographic IDs, geographic IDs). A fourth block 1208 includes determining the current values 210 of the dynamic content for the search criterion and possibly some combination of the accessed network information. In some cases, the search criterion may be executed or restricted to target an item recently lost or searched for by the user or to target specialized web sites for context (e.g., sites specializing in specific product categories or sub-categories).

For example, FIG. 13 shows a display section 1300 related to an interface for determining dynamic content by specifying sources of dynamic content. The display section 1300 includes entries for specific content providers and aggregators and the user's network behaviour. In this example the entries for content providers and aggregators include automobile-related items (MotorsDealDataProvider), daily special offers (DailyDeal), and event ticket sales (stubhub). The entries for the user's network behaviour include a merchandising algorithm that uses the user's behaviour (e.g., sites visited or not visited and items searched or not searched) to identify content (Merch) and a saved-search algorithm that uses a user's saved searches to determine to identify content (SavedSearch). A selection mark in the display section 1300 indicates that the merchandising algorithm has been selected. For example, the merchandising algorithm may identify items based on the user's purchasing history. The entries corresponding to the user's network behaviour illustrate that the data used to identify the target email recipient (e.g., as in FIGS. 8-11) can also be used to determine the dynamic content.

FIG. 14 shows another display section 1400 related to an interface for determining dynamic content by specifying a search criterion based on the user's network behavior. The display section 1400 includes algorithmic choices for options including recently viewed items (e.g., last viewed item, recently viewed items, last 10 viewed items, last lost item, last watched item, and last purchased item) and similar items (e.g., item category, active item, lost item, last viewed item, last watched item, and contextual seller IDs). Note that the choice for the search option may also be used to vary the title of displayed content (e.g., as in the dynamically generated title 402 of FIG. 4). Two selection marks in the display section 1400 indicate that the selected algorithm is based on the last lost item among the recently viewed items. In this case, the dynamic content may identically correspond to the last lost item (e.g., from an auction or a watch list) or may correspond to an alternative item.

As discussed above, both the identification of the user (e.g., FIG. 7) and the dynamic content (e.g., FIG. 12) can be based on network behaviour of users as well as other contextual features according to the requirements of the operational setting. For example, the context of a marketing email may include a generic or personalized marketing occasion (e.g., holiday shopping, birthday gifts) with a distribution list that is generated by data analysis of the users' network behaviour. The context of a transaction-based email may include follow-up marketing to a specific user after a recent purchase. The context of a more general user-activity email may be targeted to distribution list based on user activity including searches, sites and purchases.

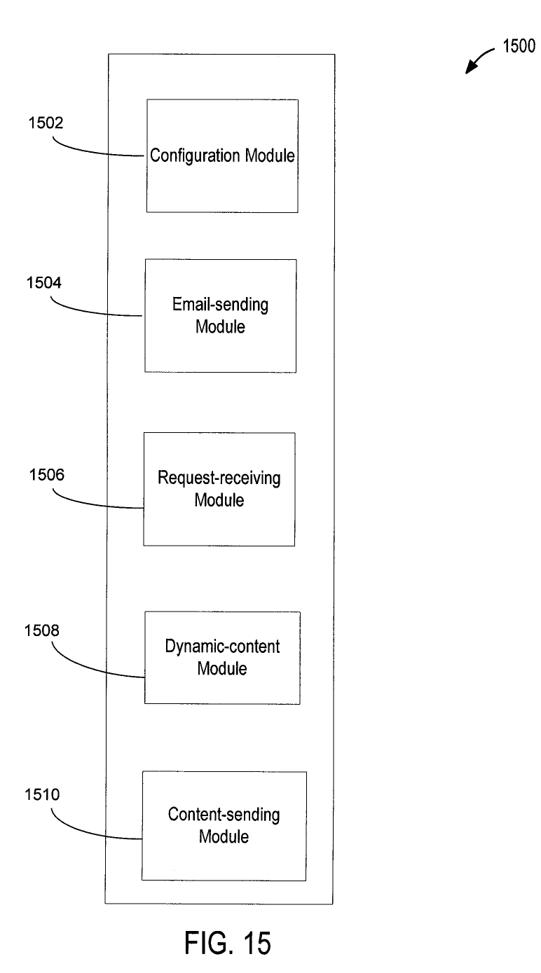

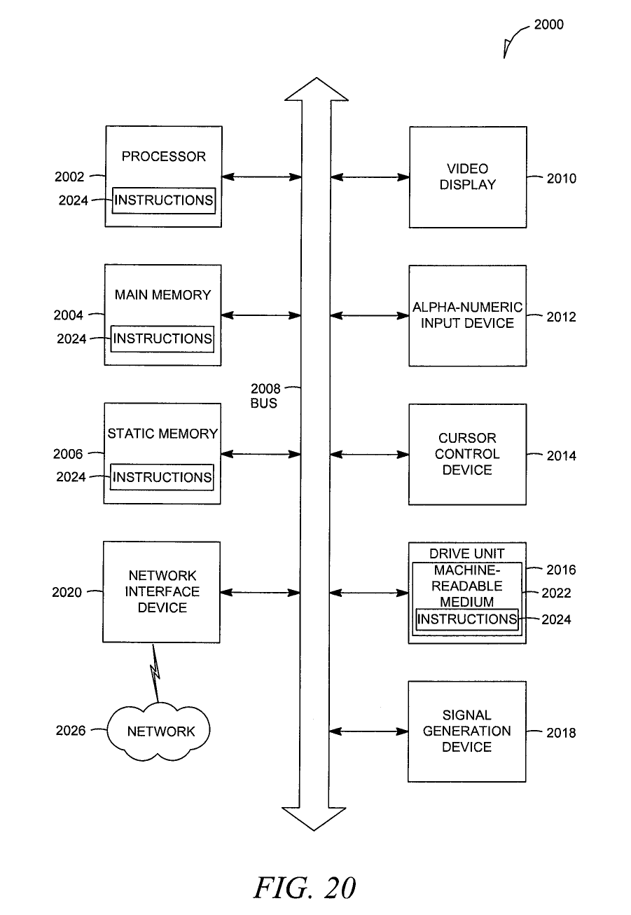

Additional embodiments relate to software and hardware implementations related to the method 100 of FIG. 1. FIG. 15 shows a schematic representation of an apparatus 1500, in accordance with an example embodiment for providing dynamic email content. In this case, the apparatus 1500 includes at least one computer system (e.g., as in FIG. 20) to perform software and hardware operations for modules that carry out aspects of the method 100 of FIG. 100.

The apparatus 1500 includes a configuration module 1502, an email-sending module 1504, a request-receiving module 1506, a dynamic-content module 1508, and a content-sending module 1510. The configuration module 1502 operates to configure a dynamic-content section in an email message to access dynamic content over a network when the email message is opened at a client machine in the network. As discussed above with reference to FIG. 1, the dynamic-content section includes a network command to request the dynamic content when the email is opened and at least one display parameter to control a display of the dynamic content in the email message at the client machine.

The email-sending module 1504 operates to send the email message to a user in the network. The request-receiving module 1506 operates to receive a dynamic-content request that corresponds to opening the email message at the client machine. The dynamic-content module 1508 operates to determine current values of the dynamic content in response to receiving the dynamic-content request. The content-sending module 1510 operates to send the current values of the dynamic content to the client machine for display in the email message at the client machine.

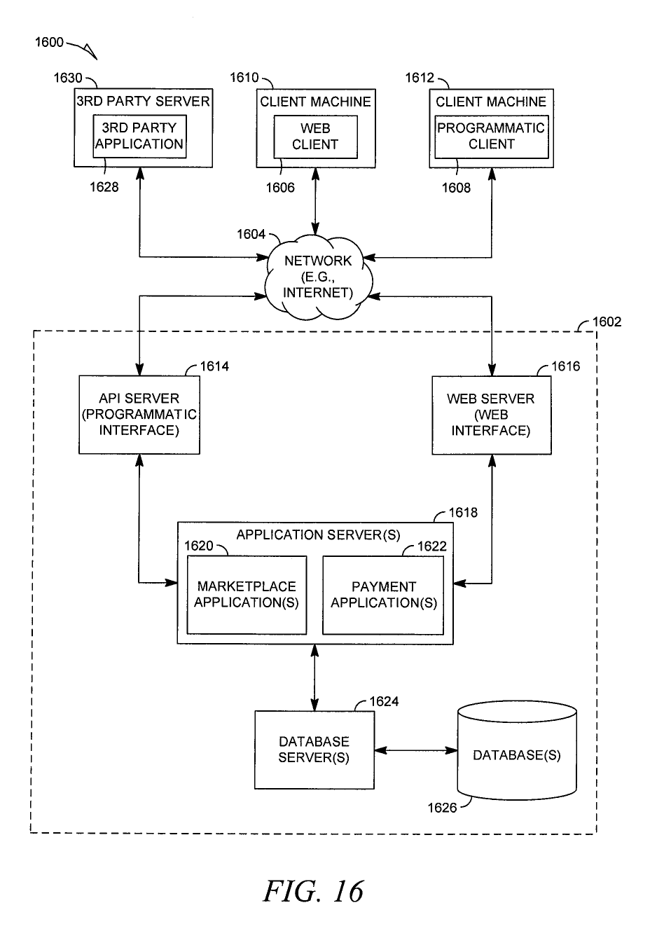

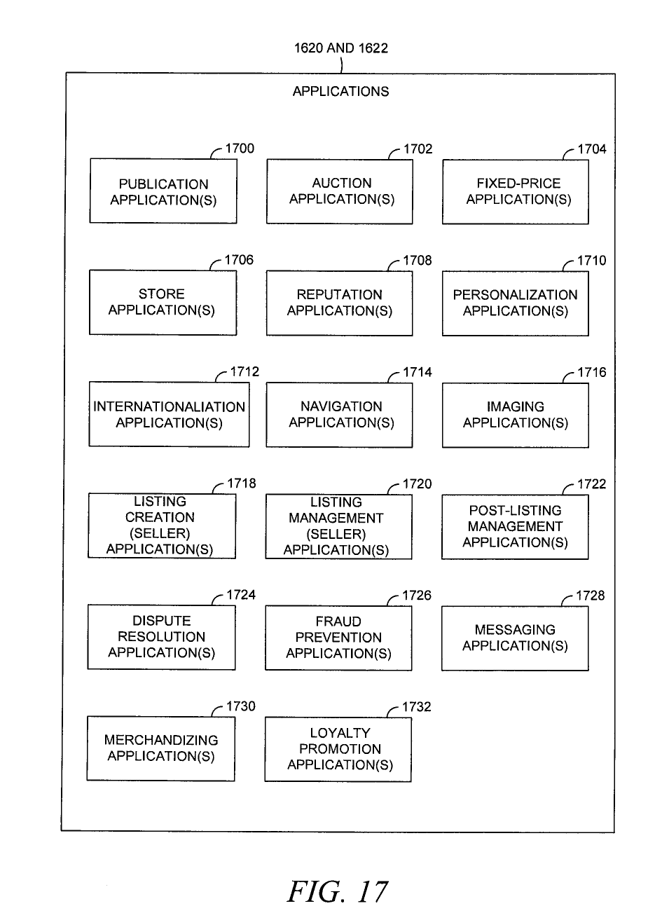

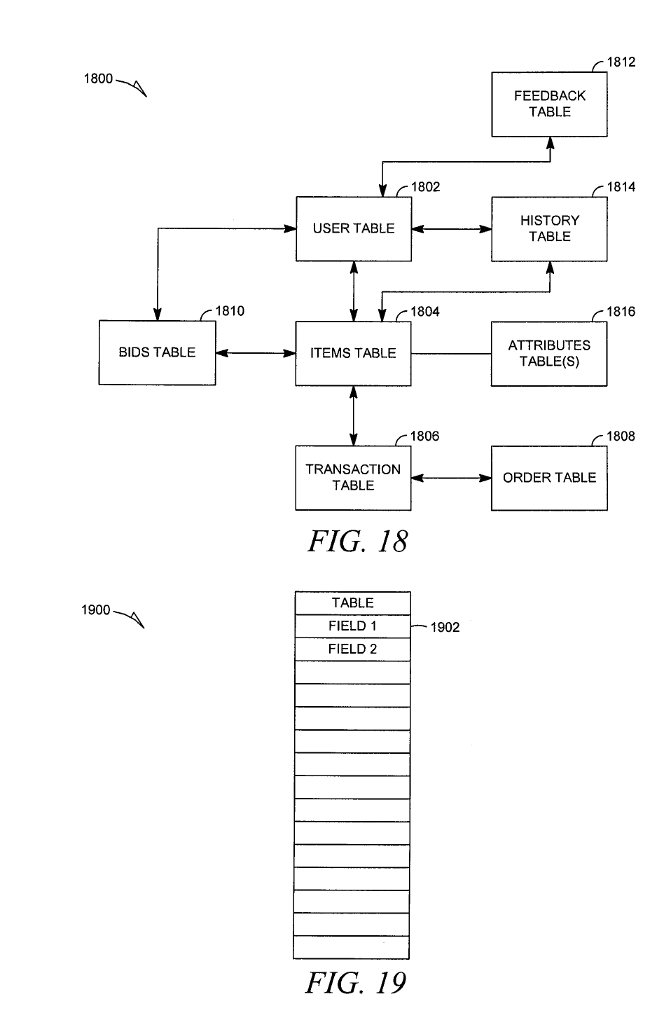

Further details related to the apparatus 1500 are discussed below with respect to FIGS. 16-20. In some embodiments, the apparatus 1500 of FIG. 15 may be considered as an integration of components related to the messaging applications 1728 and the merchandizing applications 1730 of FIG. 17. Relevant values for network information as described above can be stored in tabular data structures as shown in FIGS. 18 and 19 and as stored in the databases 1626 of FIG. 16. The user 204 then has access to email messages 208 at the client machines 1610, 1612 in the system 1600 of FIG. 16.

FIG. 16 is a network diagram depicting a client-server system 1600, within which one example embodiment may be deployed. A networked system 1602, in the example forms of a network-based marketplace or publication system, provides server-side functionality, via a network 1604 (e.g., the Internet or Wide Area Network (WAN)) to one or more clients. FIG. 16 illustrates, for example, a web client 1606 (e.g., a browser, such as the Internet Explorer browser developed by Microsoft Corporation of Redmond, Washington State), and a programmatic client 1608 executing on respective client machines 1610 and 1612.

An Application Program Interface (API) server 1614 and a web server 1616 are coupled to, and provide programmatic and web interfaces respectively to, one or more application servers 1618. The application servers 1618 host one or more marketplace applications 1620 and payment applications 1622.The application servers 1618 are, in turn, shown to be coupled to one or more databases servers 1624 that facilitate access to one or more databases 1626.

The marketplace applications 1620 may provide a number of marketplace functions and services to users that access the networked system 1602. The payment applications 1622 may likewise provide a number of payment services and functions to users. The payment applications 1622 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 1620. While the marketplace and payment applications 1620 and 1622 are shown in FIG. 16 to both form part of the networked system 1602, it will be appreciated that, in alternative embodiments, the payment applications 1622 may form part of a payment service that is separate and distinct from the networked system 1602.

Further, while the system 1600 shown in FIG. 16 employs a client-server architecture, the embodiments are, of course, not limited to such an architecture and could equally well find application in a distributed, or peer-to-peer, architecture system, for example. The various marketplace and payment applications 1620 and 1622 could also be implemented as standalone software programs, which do not necessarily have networking capabilities.

The web client 1606 accesses the various marketplace and payment applications 1620 and 1622 via the web interface supported by the web server 1616. Similarly, the programmatic client 1608 accesses the various services and functions provided by the marketplace and payment applications 1620 and 1622 via the programmatic interface provided by the API server 1614. The programmatic client 1608 may, for example, be a seller application (e.g., the TurboLister application developed by eBay Inc., of San Jose, Calif.) to enable sellers to author and manage listings on the networked system 1602 in an off-line manner, and to perform batch-mode communications between the programmatic client 1608 and the networked system 1602.

FIG. 16 also illustrates a third-party application 1628, executing on a third-party server machine 1630, as having programmatic access to the networked system 1602 via the programmatic interface provided by the API server 1614. For example, the third-party application 1628 may, utilizing information retrieved from the networked system 1602, support one or more features or functions on a website hosted by the third party. The third-party website may, for example, provide one or more promotional, marketplace or payment functions that are supported by the relevant applications of the networked system 1602.

FIG. 17 is a block diagram illustrating multiple applications 1620, 1622 that, in one example embodiment, are provided as part of the networked system 1602. The applications 1620, 1622 may be hosted on dedicated or shared server machines (not shown) that are communicatively coupled to enable communications between server machines. The applications 1620, 1622 themselves are communicatively coupled (e.g., via appropriate interfaces) to each other and to various data sources, so as to allow information to be passed between the applications 1620, 1622 or so as to allow the applications 1620, 1622 to share and access common data. The applications 1620, 1622 may furthermore access server one or more databases 1626 via the database servers 1624.

The networked system 1602 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 1620, 1622 are shown to include at least one publication application 1700 and one or more auction applications 1702 which support auction-format listing and price setting mechanisms (e.g., English, Dutch, Vickrey, Chinese, Double, Reverse auctions etc.). The various auction applications 1702 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 1704 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 1706 allow a seller to group listings within a “virtual” store, which may be branded and otherwise personalized by and for the seller. Such a virtual store may also offer promotions, incentives and features that are specific and personalized to a relevant seller.

Reputation applications 1708 allow users that transact, utilizing the networked system 1602, to establish, build and maintain reputations, which may be made available and published to potential trading partners. Consider that where, for example, the networked system 1602 supports person-to-person trading, users may otherwise have no history or other reference information whereby the trustworthiness and credibility of potential trading partners may be assessed. The reputation applications 1708 allow a user, for example through feedback provided by other transaction partners, to establish a reputation within the networked system 1602 over time. Other potential trading partners may then reference such a reputation for the purposes of assessing credibility and trustworthiness.

Personalization applications 1710 allow users of the networked system 1602 to personalize various aspects of their interactions with the networked system 1602. For example a user may, utilizing an appropriate personalization application 1710, create a personalized reference page at which information regarding transactions to which the user is (or has been) a party may be viewed. Further, a personalization application 1710 may enable a user to personalize listings and other aspects of their interactions with the networked system 1602 and other parties.

The networked system 1602 may support a number of marketplaces that are customized, for example, for specific geographic regions. A version of the networked system 1602 may be customized for the United Kingdom, whereas another version of the networked system 1602 may be customized for the United States. Each of these versions may operate as an independent marketplace, or may be customized (or internationalized) presentations of a common underlying marketplace. The networked system 1602 may accordingly include a number of internationalization applications 1712 that customize information (and/or the presentation of information) by the networked system 1602 according to predetermined criteria (e.g., geographic, demographic or marketplace criteria). For example, the internationalization applications 1712 may be used to support the customization of information for a number of regional websites that are operated by the networked system 1602 and that are accessible via respective web servers 1616.

Navigation of the networked system 1602 may be facilitated by one or more navigation applications 1714. For example, a search application (as an example of a navigation application) may enable key word searches of listings published via the networked system 1602. A browse application may allow users to browse various category, catalogue, or inventory data structures according to which listings may be classified within the networked system 1602. Various other navigation applications may be provided to supplement the search and browsing applications.

In order to make listings, available via the networked system 1602, as visually informing and attractive as possible, the marketplace and payment applications 1620, 1622 may include one or more imaging applications 1716 utilizing which users may upload images for inclusion within listings. An imaging application 1716 also operates to incorporate images within viewed listings. The imaging applications 1716 may also support one or more promotional features, such as image galleries that are presented to potential buyers. For example, sellers may pay an additional fee to have an image included within a gallery of images for promoted items.

Listing creation applications 1718 allow sellers conveniently to author listings pertaining to goods or services that they wish to transact via the networked system 1602, and listing management applications 1720 allow sellers to manage such listings. Specifically, where a particular seller has authored and/or published a large number of listings, the management of such listings may present a challenge. The listing management applications 1720 provide a number of features (e.g., auto-relisting, inventory level monitors, etc.) to assist the seller in managing such listings. One or more post-listing management applications 1722 also assist sellers with a number of activities that typically occur post-listing. For example, upon completion of an auction facilitated by one or more auction applications 1702, a seller may wish to leave feedback regarding a particular buyer. To this end, a post-listing management application 1722 may provide an interface to one or more reputation applications 1708, so as to allow the seller conveniently to provide feedback regarding multiple buyers to the reputation applications 1708.

Dispute resolution applications 1724 provide mechanisms whereby disputes arising between transacting parties may be resolved. For example, the dispute resolution applications 1724 may provide guided procedures whereby the parties are guided through a number of steps in an attempt to settle a dispute. In the event that the dispute cannot be settled via the guided procedures, the dispute may be escalated to a third-party mediator or arbitrator.

A number of fraud prevention applications 1726 implement fraud detection and prevention mechanisms to reduce the occurrence of fraud within the networked system 1602.

Messaging applications 1728 are responsible for the generation and delivery of messages to users of the networked system 1602, such messages for example advising users regarding the status of listings at the networked system 1602 (e.g., providing “outbid” notices to bidders during an auction process or to provide promotional and merchandising information to users). Respective messaging applications 1728 may utilize any one of a number of message delivery networks and platforms to deliver messages to users. For example, messaging applications 1728 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1730 support various merchandising functions that are made available to sellers to enable sellers to increase sales via the networked system 1602. The merchandising applications 1730 also operate the various merchandising features that may be invoked by sellers, and may monitor and track the success of merchandising strategies employed by sellers.

The networked system 1602 itself, or one or more parties that transact via the networked system 1602, may operate loyalty programs that are supported by one or more loyalty/promotions applications 1732. For example, a buyer may earn loyalty or promotions points for each transaction established and/or concluded with a particular seller, and be offered a reward for which accumulated loyalty points can be redeemed.

FIG. 18 is a high-level entity-relationship diagram, illustrating various tables 1800 that may be maintained within the databases 1626, and that are utilized by and support the applications 1620 and 1622. A user table 1802 contains a record for each registered user of the networked system 1602, and may include identifier, address and financial instrument information pertaining to each such registered user. A user may operate as a seller, a buyer, or both, within the networked system 1602. In one example embodiment, a buyer may be a user that has accumulated value (e.g., commercial or proprietary currency), and is accordingly able to exchange the accumulated value for items that are offered for sale by the networked system 1602.

The tables 1800 also include an items table 1804 in which are maintained item records for goods and services that are available to be, or have been, transacted via the networked system 1602. Each item record within the items table 1804 may furthermore be linked to one or more user records within the user table 1802, so as to associate a seller and one or more actual or potential buyers with each item record.

A transaction table 1806 contains a record for each transaction (e.g., a purchase or sale transaction) pertaining to items for which records exist within the items table 1804.

An order table 1808 is populated with order records, each order record being associated with an order. Each order, in turn, may be with respect to one or more transactions for which records exist within the transaction table 1806.

Bid records within a bids table 1810 each relate to a bid received at the networked system 1602 in connection with an auction-format listing supported by an auction application 1702. A feedback table 1812 is utilized by one or more reputation applications 1708, in one example embodiment, to construct and maintain reputation information concerning users. A history table 1814 maintains a history of transactions to which a user has been a party. One or more attributes tables 1816 record attribute information pertaining to items for which records exist within the items table 1804. Considering only a single example of such an attribute, the attributes tables 1816 may indicate a currency attribute associated with a particular item, the currency attribute identifying the currency of a price for the relevant item as specified in by a seller.

FIG. 19 provides further details regarding pertinent tables that are shown in FIG. 18 to be maintained within the databases 1626. As shown in FIG. 19, a table 1900 includes multiple fields 1902 to store data as described above.

FIG. 20 is a block diagram of machine in the example form of a computer system 2000 within which instructions for causing the machine to perform any one or more of the methodologies discussed here may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU), a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse or other user interface (UI) navigation device), a disk drive unit 2016, a signal generation device 2018 (e.g., a speaker) and a network interface device 2020.

In some contexts, a computer-readable medium may be described as a machine-readable medium. The disk drive unit 2016 includes a machine-readable medium 2022 on which is stored one or more sets of data structures and instructions 2024 (e.g., software) embodying or utilizing any one or more of the methodologies or functions described herein. The instructions 2024 may also reside, completely or at least partially, within the main memory 2004 and/or within the processor 2002 during execution thereof by the computer system 2000, with the main memory 2004 and the processor 2002 also constituting machine-readable media.

While the machine-readable medium 2022 is shown in an example embodiment to be a single medium, the terms “machine-readable medium” and “computer-readable medium” may each refer to a single medium or multiple media (e.g., a centralized or distributed database, and/or associated caches and servers) that store the one or more sets of data structures and instructions 2024. These terms shall also be taken to include any tangible or non-transitory medium that is capable of storing, encoding or carrying instructions for execution by the machine and that cause the machine to perform any one or more of the methodologies disclosed herein, or that is capable of storing, encoding or carrying data structures utilized by or associated with such instructions. These terms shall accordingly be taken to include, but not be limited to, solid-state memories, and optical and magnetic media.

Specific examples of machine-readable or computer-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; Compact Disc Read-Only Memory (CD-ROM) and Digital Versatile Disc Read-Only Memory (DVD-ROM).

The instructions 2024 may further be transmitted or received over a communications network 2026 using a transmission medium. The instructions 2024 may be transmitted using the network interface device 2020 and any one of a number of well-known transfer protocols (e.g., Hypertext Transfer Protocol (HTTP)). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Certain embodiments are described herein as including logic or a number of components, modules, or mechanisms. Modules may constitute either software modules or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module (e.g., a computer-implemented module) may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” (e.g., a “computer-implemented module”) should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Although only certain embodiments have been described in detail above, those skilled in the art will readily appreciate that many modifications are possible without materially departing from the novel teachings of this disclosure. For example, aspects of embodiments disclosed above can be combined in other combinations to form additional embodiments. Accordingly, all such modifications are intended to be included within the scope of this disclosure.

What is claimed is:

1. A method of providing dynamic email content, comprising:
configuring a dynamic-content section in an email message to access dynamic content over a network when the email message is opened at a client machine in the network, the dynamic-content section including a network command to request the dynamic content when the email is opened and at least one display parameter to control a display of the dynamic content in the email message at the client machine;
sending the email message to a user in the network;
receiving a dynamic-content request that corresponds to opening the email message at the client machine;
in response to receiving the dynamic-content request, determining current values of the dynamic content; and
sending the current values of the dynamic content to the client machine for display in the email message at the client machine.

2. The method of claim 1, wherein the user is a first user and the method further comprises:
accessing network information that includes network behavior of a plurality of users, the network behavior including at least one of sites visited, sites not visited, searches requested or searches not requested;
specifying at least one behavioral condition that defines a segment of users by restricting the network behavior relative to the plurality of users; and
selecting the first user from the segment of users.

3. The method of claim 1, further comprising:
specifying a search criterion for determining the dynamic content; and
determining the current values of the dynamic content by executing a search according to the search criterion in the network.

4. The method of claim 1, further comprising:
accessing network information that includes network behavior of the user, the network behavior including at least one of a site visited, a site not visited, a search requested or a search not requested;
using the network behavior of the user to identify web content; and
including values for the identified web content in the current values of the dynamic content.

5. The method of claim 1, further comprising:
accessing network information that includes contextual identifiers of a plurality of network sites, the contextual identifiers including at least one of geographical context, demographic context or categorical context;
selecting a first contextual identifier from the plurality of contextual identifiers; and
restricting the current values of the dynamic content to values that correspond to the first contextual identifier.

6. The method of claim 1, wherein the dynamic-content request is a first dynamic-content request that corresponds to opening the email message a first time, and the method further comprises:
in response to receiving the first dynamic-content request, saving a first access record in a storage system, the first access record including at least one of a user identifier, one or more of the current values of the dynamic content, and a request time when the dynamic-content request was received;
receiving a second dynamic-content request that corresponds to opening the email message a second time at the client machine;
in response to receiving the second dynamic-content request, accessing the first access record and using the first access record to determine second current values of the dynamic content; and
sending the second current values of the dynamic content to the client machine for display in the email message at the client machine.

7. The method of claim 1, wherein the dynamic-content request is a first dynamic-content request that corresponds to opening the email message a first time, and the method further comprises:
in response to receiving the first dynamic-content request, saving a first access record in a storage system, the first access record including at least one of a user identifier, one or more of the current values of the dynamic content, and a request time when the dynamic-content request was received;
receiving a second dynamic-content request that corresponds to opening the email message at a second client machine;
in response to receiving the second dynamic-content request, accessing the first access record and using the first access record to determine second current values of the dynamic content; and
sending the second current values of the dynamic content to the second client machine for display in the email message at the second client machine.

8. A non-transitory machine-readable medium that stores a set of instructions that, when executed by a machine, cause the machine to perform operations to provide dynamic email content, the operations comprising:
configuring a dynamic-content section in an email message to access dynamic content over a network when the email message is opened at a client machine in the network, the dynamic-content section including a network command to request the dynamic content when the email is opened and at least one display parameter to control a display of the dynamic content in the email message at the client machine;
sending the email message to a user in the network;
receiving a dynamic-content request that corresponds to opening the email message at the client machine;
in response to receiving the dynamic-content request, determining current values of the dynamic content; and
sending the current values of the dynamic content to the client machine for display in the email message at the client machine.

9. The machine-readable medium of claim 8, wherein the user is a first user and the set of instructions further includes instructions that, when executed by the machine, cause the machine to perform operations comprising:
accessing network information that includes network behavior of a plurality of users, the network behavior including at least one of sites visited, sites not visited, searches requested or searches not requested;
specifying at least one behavioral condition that defines a segment of users by restricting the network behavior relative to the plurality of users; and
selecting the first user from the segment of users.

10. The machine-readable medium of claim 8, wherein the set of instructions further includes instructions that, when executed by the machine, cause the machine to perform operations comprising:
specifying a search criterion for determining the dynamic content; and
determining the current values of the dynamic content by executing a search according to the search criterion in the network.

11. The machine-readable medium of claim 8, wherein the set of instructions further includes instructions that, when executed by the machine, cause the machine to perform operations comprising:
accessing network information that includes network behavior of the user, the network behavior including at least one of a site visited, a site not visited, a search requested or a search not requested;
using the network behavior of the user to identify web content; and
including values for the identified web content in the current values of the dynamic content.

12. The machine-readable medium of claim 8, wherein the set of instructions further includes instructions that, when executed by the machine, cause the machine to perform operations comprising:
accessing network information that includes contextual identifiers of a plurality of network sites, the contextual identifiers including at least one of geographical context, demographic context or categorical context;
selecting a first contextual identifier from the plurality of contextual identifiers; and
restricting the current values of the dynamic content to values that correspond to the first contextual identifier.

13. The machine-readable medium of claim 8, wherein the set of instructions further includes instructions that, when executed by the machine, cause the machine to perform operations comprising:
in response to receiving the first dynamic-content request, saving a first access record in a storage system, the first access record including at least one of a user identifier, one or more of the current values of the dynamic content, and a request time when the dynamic-content request was received;
receiving a second dynamic-content request that corresponds to opening the email message a second time at the client machine;
in response to receiving the second dynamic-content request, accessing the first access record and using the first access record to determine second current values of the dynamic content; and
sending the second current values of the dynamic content to the client machine for display in the email message at the client machine.

14. The machine-readable medium of claim 8, wherein the set of instructions further includes instructions that, when executed by the machine, cause the machine to perform operations comprising:
in response to receiving the first dynamic-content request, saving a first access record in a storage system, the first access record including at least one of a user identifier, one or more of the current values of the dynamic content, and a request time when the dynamic-content request was received;
receiving a second dynamic-content request that corresponds to opening the email message at a second client machine;
in response to receiving the second dynamic-content request, accessing the first access record and using the first access record to determine second current values of the dynamic content; and
sending the second current values of the dynamic content to the second client machine for display in the email message at the second client machine.

15. An apparatus configured to provide dynamic email content, the apparatus comprising at least one computer to perform operations for:
a configuration module to configure a dynamic-content section in an email message to access dynamic content over a network when the email message is opened at a client machine in the network, the dynamic-content section including a network command to request the dynamic content when the email is opened and at least one display parameter to control a display of the dynamic content in the email message at the client machine;
an email-sending module to send the email message to a user in the network;
a request-receiving module to receive a dynamic-content request that corresponds to opening the email message at the client machine;
a dynamic-content module to determine current values of the dynamic content in response to receiving the dynamic-content request; and
a content-sending module to send the current values of the dynamic content to the client machine for display in the email message at the client machine.

16. The apparatus of claim 15, wherein the email-sending module further provides operations for:
accessing network information that includes network behavior of a plurality of users, the network behavior including at least one of sites visited, sites not visited, searches requested or searches not requested;
specifying at least one behavioral condition that defines a segment of users by restricting the network behavior relative to the plurality of users; and
selecting the first user from the segment of users.

17. The apparatus of claim 15, wherein
the configuration module further provides operations for specifying a search criterion for determining the dynamic content; and
the dynamic-content module further provides operations for determining the current values of the dynamic content by executing a search according to the search criterion in the network.

18. The apparatus of claim 15, wherein the dynamic-content module further provides operations for:
accessing network information that includes network behavior of the user, the network behavior including at least one of a site visited, a site not visited, a search requested or a search not requested;
using the network behavior of the user to identify web content; and
including values for the identified web content in the current values of the dynamic content.

19. The apparatus of claim 15, wherein the dynamic-content module further provides operations for:
accessing network information that includes contextual identifiers of a plurality of network sites, the contextual identifiers including at least one of geographical context, demographic context or categorical context;
selecting a first contextual identifier from the plurality of contextual identifiers; and
restricting the current values of the dynamic content to values that correspond to the first contextual identifier.

20. The apparatus of claim 15, wherein the dynamic-content request is a first dynamic-content request that corresponds to opening the email message a first time, and the dynamic-content module further provides operations for:
in response to receiving the first dynamic-content request, saving a first access record in a storage system, the first access record including at least one of a user identifier, one or more of the current values of the dynamic content, and a request time when the dynamic-content request was received;
receiving a second dynamic-content request that corresponds to opening the email message a second time at the client machine;
in response to receiving the second dynamic-content request, accessing the first access record and using the first access record to determine second current values of the dynamic content; and
sending the second current values of the dynamic content to the client machine for display in the email message at the client machine.

21. The apparatus of claim 15, wherein the dynamic-content request is a first dynamic-content request that corresponds to opening the email message a first time, and the dynamic-content module further provides operations for:
in response to receiving the first dynamic-content request, saving a first access record in a storage system, the first access record including at least one of a user identifier, one or more of the current values of the dynamic content, and a request time when the dynamic-content request was received;
receiving a second dynamic-content request that corresponds to opening the email message at a second client machine;
in response to receiving the second dynamic-content request, accessing the first access record and using the first access record to determine second current values of the dynamic content; and
sending the second current values of the dynamic content to the second client machine for display in the email message at the second client machine.
